(19) United States
(12) Patent Application Publication
(10) Pub. No.: US 2008/0254174 A1
(43) Pub. Date: Oct. 16, 2008

(54) Tea Extracts

(76) Inventors: Thomas Alexander Fritz Dimitrijevic, Shambrook (GB); John Emmet O'Connell, Kerry (IE)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/579,400

(22) PCT Filed: Apr. 21, 2005
(86) PCT No.: PCT/EP2005/04405

§ 371 Date: Nov. 2, 2006

(30) Foreign Application Priority Data
May 4, 2004 (GB) 04096846.3

(51) Int. Cl. A23F 3/20

(52) U.S. Cl. 426/239; 426/597; 426/271

(57) ABSTRACT

A tea extract comprising tea solids derived from an aqueous infusion of tea plant material, said tea extract comprising magnesium, manganese, calcium and potassium ions in such amounts that the Euclidean Distance calculated using Formula (I) in which [Mg] is the concentration of magnesium ions in ppm, [Mn] is the concentration of manganese ions in ppm, [Ca] is the concentration of calcium ions in ppm and [K] is the concentration of potassium ions in ppm is less than 1.76.

The present invention relates to tea extracts and to process for the manufacture of tea extracts.

### BACKGROUND AND PRIOR ART

The tea extracts of the present invention are concentrated tea extracts. As used herein the term “concentrated tea extract” means a tea-containing composition in which the amount of tea solids present is greater than would be present in a tea beverage intended to be consumed by a consumer. Concentrated tea extracts may be powders or liquids. The amount of tea solids in a liquid concentrated tea extract may be greater than 3%, preferably greater than 8%, more preferably greater than 12% by weight of the tea concentrate. Concentrated tea extracts may be produced by direct extraction into water or by partially or completely removing the water from an infusion of tea leaves in water to give liquid and powder concentrated tea extracts respectively.

Tea extracts having an amount of tea solids usually associated with tea beverages suitable for consumption by a consumer are hereinafter referred to as “consumable tea extracts”. Consumable tea extracts may comprise an amount of tea solids which may be less than 1%, preferably less than 0.8%, more preferably less than 0.5% by weight of the tea extract. In particularly preferred consumable tea extracts, the amount of tea solids in the tea extract may be in the range 0.04 to 0.35% by weight of the tea extract

As used herein the term “tea beverage” means a tea-containing composition which is suitable for consumption by the consumer. A tea beverage may be a consumable tea extract or it may be made by adding water (hot or cold) to concentrated tea extracts. Tea beverages may be made by adding the water to the concentrated tea extracts immediately prior to consumption or they may be prepared and placed in a container (for example a bottle or can) for supply to the consumer as a ready-to-drink tea beverage.

One problem which occurs in tea extracts, particularly concentrated tea extracts, is that over time they develop a haze which makes the appearance of a tea beverage made from them less attractive to the consumer. This haze is caused by the presence of, or the formation of, water insoluble compounds in the tea extract. Attempts have been made to remove the water insoluble compounds from infusions of tea by a process known as decreaming. In such a process, the insoluble tea cream is separated from the “decreamed” fraction (which is the term given to the cold water soluble materials after removal of the cold water insoluble cream). This is typically accomplished by centrifugation of the chilled (2-25° C.) infusion. The insoluble cream fraction however represents a significant proportion of the tea solids in the infusion. Accordingly, to prevent the cream fraction (which contains desirable tea components) going to waste, it is known to treat the cream fraction, in one of a number of ways, so as to render it soluble in cold water and then to recombine the solubilised cream with the decreamed fraction. Various treatments of the cream fraction of tea infusions are described, for example, in GB 1,311,255, GB 1,461,726, U.S. Pat. No. 3,787,590 and U.S. Pat. No. 4,156,024.

Whilst the above methods may reduce the amount of potentially insoluble material in the tea infusion, they will inevitably result in the loss of tea components leading to a tea beverage which is less acceptable to the consumer than one in which substantially all the tea solids which were present in the initial infusion are still present. There is therefore a need to provide tea extracts which are haze-free when they are first produced and which do not develop haze on storage but which contain the maximum amount of those components which give the tea beverage a taste and aroma that appeals to the consumer. The present applicants have now surprisingly found that by controlling the relative metal ion concentration, particularly the potassium, calcium, manganese and magnesium ion concentrations, in an extract, a tea beverage can be produced which has improved clarity.

Additionally we have found that such low metal ion content extracts can provide an antimicrobial effect in ready-to-drink beverages and that therefore this allows lower concentrations of preservative to be used.

According to a first aspect of the present invention, there is provided a tea extract comprising tea solids derived from an aqueous infusion of tea plant material, said tea extract comprising magnesium, manganese, calcium and potassium ions in such amounts that the Euclidean Distance calculated using Formula 1

$$\sqrt{{( \frac{[ Mg ]}{1100} )}^{2} + {( \frac{[ Mn ]}{400} )}^{2} + {( \frac{[ Ca ]}{630} )}^{2} + {( \frac{[ K ]}{40000} )}^{2}} \qquad Formula 1$$

in which [Mg] is the concentration of magnesium ions in ppm, [Mn] is the concentration of manganese ions in ppm, [Ca] is the concentration of calcium ions in ppm and [K] is the concentration of potassium ions in ppm
is less than 1.76.
The Euclidean Distance is calculated by
a) standardising the levels of the four metal ions such that the four become comparable in size. The standardisation is performed by dividing the metal ion concentration in ppm
b) combining the four standardised metal ion levels to give the Euclidean Distance by using Formula 1

In the calculations using formula 1 above the concentrations of the metal ions were determined by

Preferably the amount of potassium ions is no more than 25000 ppm, more preferably no more than 20000 ppm, most preferably no more than 15000 ppm.

In preferred embodiments of the invention the amount of potassium ions present is in the range 1000 to 25000, preferably 3000 to 20000, most preferably 5000 to 15000 ppm.

Preferably the amount of magnesium ions is no more than 1000 ppm, more preferably no more than 800 ppm, most preferably no more than 600 ppm.

In preferred embodiments of the invention the amount of magnesium ions present is in the range 0 to 1000, preferably 50 to 800, most preferably 100 to 600 ppm.

Preferably the amount of manganese ions is no more than 300 ppm, more preferably no more than 200 ppm, most preferably no more than 100 ppm.

In preferred embodiments of the invention the amount of manganese ions present is in the range 0 to 300, preferably 15 to 200, most preferably 30 to 100 ppm.

Preferably the amount of calcium ions is no more than 500 ppm, more preferably no more than 200 ppm, most preferably no more than 100 ppm.

In preferred embodiments of the invention the amount of calcium ions present is in the range 0 to 500, preferably 15 to 200, most preferably 30 to 100 ppm.

Because we have found that electrodialised tea extract has a longer shelf-life, it can comprises a reduced amount of preservative. Thus, preferably the tea extract comprises a total of from 100 to 300 ppm of benzoate and/or sorbate preservatives.

The concentrated tea extracts of the present invention may additionally contain one or more carbohydrates such as sucrose or corn syrup preferably high fructose corn syrup (HFCS) preferably with a DE of 42 or 55, so that the ratio of carbohydrate solids to tea solids is in the range 1:1 to 3:1, preferably 2:1. The carbohydrate should be of a type and at a level such that it does not impart significant sweetness when the concentrated tea extract is diluted to give a tea beverage. Other materials may also be used but the total solids (solute) concentration including tea, HFCS, or other carbohydrate, and any optionally added other additives such as acidulants, preservatives and colorants, is preferably at least about 40% to ensure stability. In liquid concentrated tea extracts of the present invention, a pH of about 4.6 or lower is preferably used.

According to a second aspect of the present invention there is provided a tea beverage produced from a concentrated tea extract of the present invention.

According to a third aspect of the present invention there is provided a process for preparing a concentrated tea extract comprising the steps of:—

a) preparing an aqueous infusion of tea leaves
b) concentrating the infusion
c) adjusting the relative amounts of magnesium, manganese, calcium and potassium ions in the infusion or the concentrated infusion to give a tea extract in which the Euclidean Distance calculated using Formula 1

$$\sqrt{{( \frac{[ Mg ]}{1100} )}^{2} + {( \frac{[ Mn ]}{400} )}^{2} + {( \frac{[ Ca ]}{630} )}^{2} + {( \frac{[ K ]}{40000} )}^{2}} \qquad Formula 1$$

in which [Mg] is the concentration of magnesium ions in ppm in the tea extract, [Mn] is the concentration of manganese ions in ppm in the tea extract, [Ca] is the concentration of calcium ions in ppm in the tea extract and [K] is the concentration of potassium ions in ppm in the tea extract
is less than 1.76.

In a preferred process according the present invention the relative amounts of the magnesium, manganese, calcium and potassium ions may be adjusted by electrodialysis. In preferred processes of the present invention the electrodialysis is performed using a strongly acidic cation permeable membrane and a strongly basic anion permeable membrane. A suitable strongly acidic cation permeable membrane is one which consists of a polyvinylchloride inert matrix with attached sulphonate or carboxylate groups for example membranes available from Eurodia under the designation CMX (for example CMX-SB having sulphonate groups). A suitable strongly basic anion permeable membrane is one which consists of a polyvinylchloride inert matrix with attached quaternary ammonium groups for example membranes available from Eurodia under the designation ASM.

The concentrated tea extracts of the present invention may be prepared by a process comprising the steps of:—
a) infusing tea plant material in water to give an aqueous infusion containing tea solids
b) removing the plant material for example by filtration and/or centrifugation
c) optionally concentrating the infusion
d) optionally treating the infusion with one or more enzymes
e) decreasing the infusion
f) concentrating the decreamed infusion,
g) adjusting the relative amounts of magnesium, manganese, calcium and potassium ions in the infusion by electrodialysis to give a tea extract in which the Euclidean Distance calculated using Formula 1 above is less than 1.76
h) optionally adding carbohydrate
i) concentrating the electrodialysed tea extract to give a liquid concentrated tea extract
j) optionally adding components conventionally used in tea products, for example preservatives, pH adjusting agents colourings and/or flavours, and
k) optionally dehydrating the liquid concentrated tea extract to give a concentrated tea extract in the form of a powder.

In the above process the ratio of tea plant material to water in infusion step (a) may be in the range 1:3 to 1:20, preferably in the range 1:5 to 1:15, more preferably in the range 1:6 to 1:12.

The optional concentration process in step (c) above may be performed for example using a falling film evaporator suitably to obtain a tea solids content in the range 6 to 10%.

In preferred embodiments of the above process the tea infusion is treated in step (d) with one or more enzymes for example with at least one cell wall digesting enzyme such as carbohydrases including cellulase and mascerase, for example, Viscozyme™ L obtainable from NOVO Industri A/S Denmark.

The decreaming step at (e) above may be performed by cooling the extract to a temperature in the range 3 to 55° C. and removing any precipitated cream by for example centrifugation.

In optional concentration step (f) above the decreamed infusion may be concentrated to a tea solids content in the range 5 to 20%, preferably in the range 8 to 15% and more preferably 10 to 12%. Suitable equipment for concentrating the extract would include a falling film evaporator.

The electrodialysis in step (g) above may be performed using a strongly acidic cation permeable membrane and a strongly basic anion permeable membrane. A suitable strongly acidic cation permeable membrane is one which consists of a polyvinylchloride inert matrix with attached sulphonate or carboxylate groups for example membranes available from Eurodia under the designation CMX (for example CMX-SB having sulphonate groups). A suitable strongly basic anion permeable membrane is one which consists of a polyvinylchloride inert matrix with attached quaternary ammonium groups for example membranes available from Eurodia under the designation ASM. The manipulation of the pH of the decreamed infusion before and after electrodialysis may be achieved through the use of suitable pH adjusting agents such as phosphoric acid, hydrochloric acid and sodium hydroxide.

In the optional carbohydrate addition step (h) above one or more carbohydrates such as sucrose or corn syrup preferably high fructose corn syrup (HFCS) preferably with a DE of 42 or 55 may be added, so that the ratio of carbohydrate solids to tea solids is in the range 1:1 to 3:1, preferably 2:1. The carbohydrate should be of a type and at a level such that it does not impart significant sweetness when the concentrated tea extract is diluted to give a tea beverage.

In concentration step (i) above the electrodialysed extract may be concentrated to a total solids content in the range 35 to 70% preferably around 50%. Suitable equipment for concentrating the extract would include a falling film evaporator.

The optimal addition of other conventional components in step (j) may include suitable preservatives for use in the tea extracts such as sorbate and benzoate, preferably sodium benzoate and potassium sorbate but any preservatives commonly used in tea beverage may be used. Typically, the concentrated tea extracts of the present invention contain about 800 to 1200 ppm each of sorbate and benzoate. As an alternative to using preservatives the tea extract may be pasteurised and aseptically filled.

Suitable pH adjusting agents include acidulants such as citric acid or phosphoric acid.

In optional dehydration step (k) the water may be removed by any known means for example by spray drying.

### EXAMPLES

### Example 1

(1) Tea leaf added to water (90° C.) at a water to leaf ratio of 10:1 and extracted at 900° C. for 10 min.
(2) Leaf material was removed by filtration through muslin cloth and centrifugation at 6,000 g for 30 sec.
(3) Deleafed tea extract was incubated with viscozyme (Novozyme; 1.7 g viscozyme/100 g tea solids) at 55° C. for 30 min and concentrated 8% solids using a falling film evaporator.
(4) The tea concentrate was cooled to 25° C. and decreased by centrifuging at 6,000 g for 30 sec at 25° C.
(5) The decreased extract was adjusted to pH 2.0 using 5 M HCl.
(6) The resulting concentrate was electrodialysed using a Euro 2 20 pilot plant unit at Eurodia's Research and Development facility (Wissous, Paris). The ED unit stack had a surface area of 0.4 m² and was fitted with Eurodia CMX-SB and ASM membranes. The system was run at 45° C.

The operating conditions were:—

| Flow rate: | 180 | L/h |
|---|---|---|
| Electrical conditions: | Constant voltage of 14 V | |
| Brine concentrations: | NaCl 5 | g/L |
| Electrolyte conditions: | NaCl 13.5 | g/L |
| Surface area per unit volume: | 0.1 | m²/L |

(7) Electrodialysed decream was readjusted to pH 4.1-4.3 using 2.0 M NaOH. High fructose corn syrup and corn syrup were added in a ratio 2.6:1 to give a final ratio of 1.9:1 syrups:tea. This was then concentrated to 58% solids, chemically preserved by standard methods and subsequently stored as a liquid concentrate.

The tea concentrate from step 7 above was analysed for its potassium, magnesium, manganese and calcium ion content as will now be described.

The samples were digested using a CEM (Microwave Technology) Ltd, MARSₓ Closed vessel microwave digestion system with high pressure XPl500 plus vessels and TFM liners. 0.5 g sample was digested in 4 ml BDH Aristar grade Nitric acid. Digests were heated by a ramped temperature program to a temperature of 175° C. and held there for 20 minutes. Once cool, digests were transferred to acid-washed 100 ml volumetrics and made up to volume with Millipore, MilliQ ultrapure water, greater than 18.0 MOhm conductivity. Standards of a suitable concentration, were prepared from BDH Aristar grade single element stock standards. These standards together with a blank were prepared in the same acid concentration as the samples.

The samples were analysed against the standards by Inductively Coupled Plasma-Atomic Emission Spectroscopy (ICP-AES). A PerkinElmer OPTIMA 3000DV ICP-AES with PerkinElmer, ICP WinLab™ Version 1.42 software was used together with a PerkinElmer AS90 autosampler. The samples were introduced to the plasma by Low-Flow GemCone Nebuliser with Cyclonic Spray Chamber. The Instrumental conditions and wavelengths used are given below.

### Instrumental Conditions

Plasma argon flow: 15 L/minute
Auxiliary argon flow: 0.5 L/minute
Nebuliser argon flow: 0.75 L/minute
Plasma power: 1400 Watts
Viewing height: 15 mm
Sample flow rate: 1 ml/minute
Calibration: Linear, forced through zero

| Element | Wavelength | Background correction | Plasma view |
|---|---|---|---|
| Calcium | 422.673 nm | −0.078, 0.078 | Radial |
| Potassium | 766.491 nm | −0.139, 0.139 | Radial |
| Magnesium | 279.079 nm | −0.026, 0.026 | Axial |
| Manganese | 257.610 nm | −0.023, 0.023 | Radial |

Similar tea concentrate that had been treated in a similar way to that described above in Example 1 but which had not been electrodialysed were also analysed. Results from metal ion analysis are shown in Table 1.

TABLE 1

| | Metal ion concentration | Metal ion concentration |
|---|---|---|
| | of electrodialysed tea | of untreated tea |
| Metal ion | concentrate (ppm) | concentrate (ppm) |
| Potassium | 5898 | 51641 |
| Magnesium | 100 | 4374 |
| Manganese | 38 | 1361 |
| Calcium | 38 | 700 |

The haze of the tea concentrate from step 7 above was measured. The haze of a similar tea concentrate that had been treated in a similar way to that described above but which had not been electrodialysed was also measured. Results from the haze measurement are shown in table 2.

Samples were reconstituted at ˜0.28% w/w tea solids in synthetic hard water* as follows. Tea extract equivalent to 0.375 g solids was weighed into a plastic beaker. To this 26.7 g of hot water (˜92° C.) was added and the mixture swirled to ensure complete mixing. Dilution was completed by the immediate addition of cold water (107.1 g).

The sample was then allowed to equilibrate at room temperature (normally 30-60 minutes). Haze was then determined using the HunterLab Ultrascan XE colourimeter under the following settings:

| | |
|---|---|
| Colour System: | CIELab |
| Illuminant: | C |
| Observer Angle: | 2° |
| Cell Size: | 5 cm (Minimum volume 100 ml) |

* Synthetic hard water contains 135 ppm of CaCl₂, 73 ppm MgSO₄ and 62 ppm of NaHCO₃.

TABLE 2

| Haze in synthetic hard | Haze in synthetic hard |
|---|---|
| water of electrodialysed | water of untreated |
| tea concentrate | tea concentrate |
| 10.4 | 47.5 |

1. A concentrated tea extract comprising tea solids derived from an aqueous infusion of tea plant material in an amount of greater than 3% by weight of the tea extract, said tea extract comprising magnesium, manganese, calcium and potassium ions in such amounts that the Euclidean Distance calculated using Formula 1:
$$\sqrt{{( \frac{[ Mg ]}{1100} )}^{2} + {( \frac{[ Mn ]}{400} )}^{2} + {( \frac{[ Ca ]}{630} )}^{2} + {( \frac{[ K ]}{40000} )}^{2}} \qquad Formula 1$$
In which [Mg] is the concentration of magnesium ions in ppm, [Mn] is the concentration of manganese ions in ppm, [Ca] is the concentration of calcium ions in ppm and [K] is the concentration of potassium ions in ppm is less than 1.76.

2. A concentrated tea extract as claimed in claim 1, wherein the tea extract comprises tea solids in an amount of greater than 12% by weight of the tea extract.

3. A concentrated tea extract as claimed in claim 1 wherein the concentration of potassium ions is less than 25000 ppm.

4. A concentrated tea extract as claimed in claim 3 wherein the concentration of potassium ions is less than 15000 ppm.

5. A concentrated tea extract as claimed in claim 1, which comprises a total of from 100 to 300 ppm of benzoate and/or sorbate preservatives.

6. A process for preparing a concentrated tea extract comprising tea solids in an amount of greater than 3% by weight of the tea extract, the process comprising the steps of:—
(a) preparing an aqueous infusion of tea leaves
(b) concentrating the infusion
(c) adjusting the relative amounts of magnesium, manganese, calcium and potassium ions in the concentrated infusion to give a tea extract in which the Euclidean Distance calculated using Formula 1:
$$\sqrt{{( \frac{[ Mg ]}{1100} )}^{2} + {( \frac{[ Mn ]}{400} )}^{2} + {( \frac{[ Ca ]}{630} )}^{2} + {( \frac{[ K ]}{40000} )}^{2}} \qquad Formula 1$$
In which [Mg] is the concentration of magnesium ions in ppm in the tea extract, [Mn] is the concentration of manganese ions in ppm in the tea extract, [Ca] is the concentration of calcium ions in ppm in the tea extract and [K] is the concentration of potassium ions in ppm in the tea extract is less than 1.76.

7. A process as claimed in claim 6, wherein the relative amounts of the magnesium, manganese, calcium and potassium ions are adjusted by electrodialysis.

8. A process for preparing concentrated tea extracts comprising the steps of:—
(a) infusing tea plant material in water to give an aqueous infusion containing tea solids
(b) removing the plant material for example by filtration and/or centrifugation
(c) optionally concentrating the infusion
(d) optionally treating the infusion with one or more enzymes
(e) decreaming the infusion
(f) concentrating the decreamed infusion,
(g) adjusting the relative amounts of magnesium, manganese, calcium and potassium ions in the infusion by electrodialysis to give a tea extract in which the Euclidean Distance calculated using Formula 1 above is less than 1.76
(h) optionally adding carbohydrate
(i) concentrating the electrodialysed tea extract to give a liquid concentrated tea extract
(j) optionally adding components conventionally used in tea products, for example, preservatives, pH adjusting agents colourings and/or flavours, and
(k) optionally dehydrating the liquid concentrated tea extract to give a concentrated tea extract in the form of a powder.
